(19) United States
(12) Patent Application Publication
(10) Pub. No.: US 2026/0149916 A1
(43) Pub. Date: May 28, 2026

(54) INFORMATION PROVISION SYSTEM, INFORMATION PROVISION METHOD, AND STORAGE MEDIUM

(71) Applicant: JTEKT CORPORATION, Kariya-shi (JP)

(72) Inventors: Yoshiyuki SHIBATA, Toyota-shi (JP); Hiroki UMEZAWA, Nagoya-shi (JP)

(73) Assignee: JTEKT CORPORATION, Kariya-shi (JP)

(21) Appl. No.: 19/329,940

(22) Filed: Sep. 16, 2025

(30) Foreign Application Priority Data
Sep. 24, 2024 (JP) 2024-165118

(51) Int. Cl. H04R 1/32; H04S 7/00

(52) U.S. Cl. CPC H04R 1/323; H04S 7/303; H04S 7/40

(57) ABSTRACT

An information provision system includes a processor. The processor acquires distances between a first user among a plurality of users and all other users among the plurality of users. When the first user satisfies a determination condition determined in advance, the processor provides information determined in advance to the first user and a second user group that is some or all of users located at the distances less than a threshold distance determined in advance among the all other users at the same time, and the processor does not provide the information to a third user group that is some or all of users located at the distances equal to or greater than the threshold distance among the all other users.

### CROSS-REFERENCE TO RELATED APPLICATION

This application claims priority to Japanese Patent Application No. 2024-165118 filed on Sep. 24, 2024. The disclosure of the above-identified application, including the specification, drawings, and claims, is incorporated by reference herein in its entirety.

### BACKGROUND

### 1. Technical Field

The present disclosure relates to an information provision system, an information provision method, and a storage medium.

### 2. Description of Related Art

A technique of providing information corresponding to position information of a user is known. Japanese Unexamined Patent Application Publication No. 2009-245389 (JP 2009-245389 A) describes a technique of providing information at the same time to all terminals when all or some of the terminals that are grouped enter a predetermined area on a map. This makes it possible to, when a plurality of people behaves in a group, provide information to all the people at the same timing.

### SUMMARY

Examples of information to be provided can include information for guiding a user within an area. When the information is provided if some of terminals enter the area, the information is provided to respective owners of other terminals that do not enter the area even if the other terminals are far from a target of guiding, and thus, there is a possibility that the owners of the other terminals cannot enjoy the provided information. Further, when the information is provided if all the terminals enter the area, it takes time until the information is provided to an owner of a terminal that has entered the area first, and the owner has passed through the target of guiding, and there is a possibility that the owner cannot enjoy the provided information.

The present disclosure can be implemented in the following aspects.

According to an aspect of the present disclosure, an information provision system is provided. The information provision system includes a processor. The processor is configured to acquire distances of a first user among a plurality of users and all other users other than the first user among the plurality of users. When the first user satisfies a determination condition determined in advance, the processor is configured to provide information determined in advance at the same time to the first user and a second user group that is some or all of users located at the distances less than a threshold distance determined in advance among the all other users and is configured not to provide the information to a third user group that is some or all of users located at the distances equal to or greater than the threshold distance among the all other users.

According to the information provision system of this aspect, when the first user satisfies the condition, the information is provided at the same time to the second user group located at the distances less than the threshold distance from the first user, and to the first user, so that the second user group can share enjoyment of the information with the first user. Further, the information is not provided to the third user group located at the distances equal to or greater than the threshold distance from the first user, so that it is possible to prevent the information from being provided at a timing at which the third user group cannot enjoy the information. It is therefore possible to provide the information at a timing appropriate for each of the plurality of users.

In the information provision system of the above-described aspect, the determination condition may include entry into a first region determined in advance on a map. According to such an aspect, when the first user enters a range determined in advance, the information can be provided.

In the information provision system of the above-described aspect, the processor may further provide the information to a fourth user group that is some or all of users that satisfy the determination condition among the third user group, and when the information is being provided to the first user, and the distance between the first user and the fourth user group is less than the threshold distance, synchronize a degree of progress of provision of the information to the first user with a degree of progress of provision of the information to the fourth user group. According to such an aspect, when the distance between the first user and the fourth user group approaches less than the threshold distance, the processor synchronizes provision of the information to the first user with provision of the information to the fourth user group. Thus, even if the first user and the fourth user group approach each other after provision of the information to the first user is started, the first user and the fourth user group can share enjoyment of the information at the same timing.

In the information provision system of the above-described aspect, the first region may include a position of an explanation target of the information. The second user group may be some or all of users who are located at the distances less than the threshold distance among the all other users, and who are located in a second region determined in advance the second region includes the first region and from which the explanation target is visible. According to such an aspect, the second user group can enjoy provision of the information while visually confirming the explanation target of the information to be provided.

In the information provision system of the above-described aspect, the threshold distance when the first user is located on a road with a first width is greater than the threshold distance when the first user is located on a road with a second width that is smaller than the first width. According to such an aspect, it is possible to set the threshold distance appropriate for a position of the first user.

The information provision system of the above-described aspect that provides the information using sound may further include a sound reproduction device to be worn on a head of each of the plurality of users. The processor may be configured to provide the sound as the information. The sound reproduction device may be configured to reproduce the information subjected to stereophonic processing. The information subjected to stereophonic processing expresses a position of a sound source that is a virtual generation source of sound as a relative position determined in advance with respect to the user who wears the sound reproduction device. According to such an aspect, the sound reproduction device reproduces the sound subjected to stereophonic processing. Thus, the information provision system can provide the information to the user while causing the user to feel a realistic feeling.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating a configuration of an information provision system;

FIG. 2 is a view illustrating an example of a positional relationship of users;

FIG. 3 is a flowchart indicating an example of information provision processing;

FIG. 4 is a view illustrating an example of a positional relationship of users in a second embodiment; and

FIG. 5 is a flowchart indicating an example of synchronization processing.

### DETAILED DESCRIPTION OF EMBODIMENTS

### First Embodiment

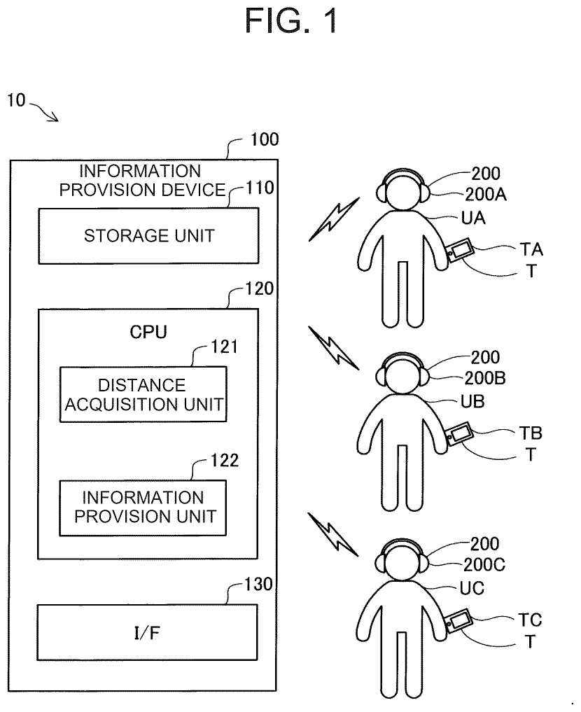

FIG. 1 is a view illustrating a configuration of an information provision system 10 according to the present embodiment. The information provision system 10 provides information for guiding users and providing explanation to each of three users UA, UB, UC in accordance with distances to a first user. In the present embodiment, the first user is a user determined in advance and is the user UA. Further, the information provision system 10 provides information using sound. The information provision system 10 includes an information provision device 100, a terminal device T, and a sound reproduction device 200. A case will be described below as an example where a user is walking around a sightseeing area while carrying the terminal device T.

In the present embodiment, the terminal device T is a smartphone. The terminal device T includes a first terminal device TA, a second terminal device TB, and a third terminal device TC. The first terminal device TA is possessed by the user UA. The second terminal device TB is possessed by the user UB. The third terminal device TC is possessed by the user UC.

The sound reproduction device 200 is a portable device that outputs sound indicated by a signal received from the information provision device 100 through the terminal device T. The sound reproduction device 200 is a device to be worn on the head of the user and is, for example, earphones to be worn on both ears. A first sound reproduction device 200A is worn on the head of the user UA. A second sound reproduction device 200B is worn on the head of the user UB. The user moves in the sightseeing area while wearing the sound reproduction device 200 on his/her head. Note that the terminal device T and the sound reproduction device 200 may be an integrated device.

The information provision device 100 is a device that provides one or more pieces of information to the users UA, UB, UC. The information provision device 100 is constituted with a computer including a central processing unit (CPU 120), a RAM, and a ROM and implements functions of respective units with a distance acquisition unit 121 and an information provision unit 122 by the CPU 120 executing programs installed in advance in a memory 110 of the information provision device 100. The information provision system 10 includes an input/output interface 130 to which a communication device (not illustrated) for performing communication with outside through wireless communication is connected. However, some or all of the functions of the respective units may be implemented by hardware circuits. In the present embodiment, the information provision system 10 is a server device.

The memory 110 records sound data that is information to be provided to the user.

The distance acquisition unit 121 acquires distances between the first user and all other users. In the present embodiment, the distance acquisition unit 121 acquires position information including latitude and longitude indicating current positions of the user UA, the user UB and the user UC and calculates a distance between the user UA and the user UB, and a distance between the user UA and the user UC. More specifically, the distance acquisition unit 121 calculates the distance using the position information detected by the terminal device T using a global navigation satellite systems (GNSS) such as a global positioning system (GPS).

The information provision unit 122 reproduces the information from the sound reproduction device 200 via the terminal device T owned by the user UA and provides the information. In the present embodiment, the information provision unit 122 performs stereophonic processing on sound. More specifically, the stereophonic processing is performed on the sound such that the user recognizes a position of a sound source that is a virtual generation source of the sound provided to the user from the sound reproduction device 200 worn on the head of the user, as a relative position determined in advance with respect to the user.

Typically, the stereophonic processing is processing of causing the sound reproduction device 200 to stereophonically reproduce a sound environment by introducing at least one or more kinds of processing of a volume difference, a time difference, change of frequency characteristics, change of a phase, and change of echo into sound to be reproduced at the right ear and the left ear. As the stereophonic processing, for example, an existing algorithm for generating stereophony is used. The information provision unit 122, for example, executes a stereophonic processing program stored in the memory 110 to perform the stereophonic processing. By performing stereophonic processing on sound information, it is possible to generate a difference between a timing and a sound pressure of sound to be reproduced at the right ear and a timing and a sound pressure of sound to be reproduced at the left ear. For example, a timing of sound to be reproduced at the ear closer to the sound source is made earlier than a timing of sound to be reproduced at the ear farther from the sound source, and a sound pressure of the sound to be reproduced at the ear closer to the sound source is made larger than a sound pressure of the sound to be reproduced at the ear farther from the sound source.

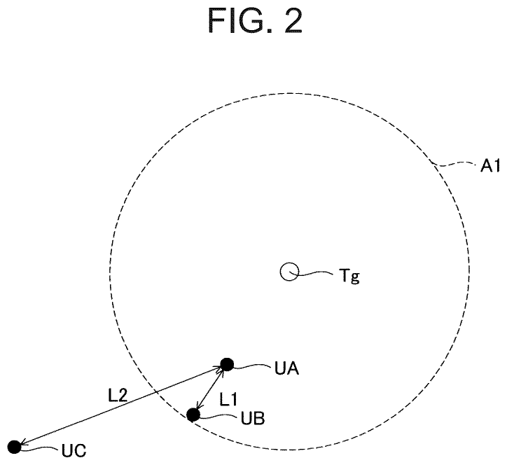

FIG. 2 is a view illustrating an example of a positional relationship of the users. A distance L1 between the user UA and the user UB is less than a threshold distance Lth determined in advance. A distance L2 between the user UA and the user UC is equal to or greater than the threshold distance Lth. Details of the threshold distance Lth will be described later. The user UA and the user UB are located within a range A1 determined in advance on a map. The range A1 includes a position of an explanation target Tg of information to be provided. The explanation target Tg is, for example, a historical spot, a scenic spot, an artwork, or the like, which is a tourist attraction.

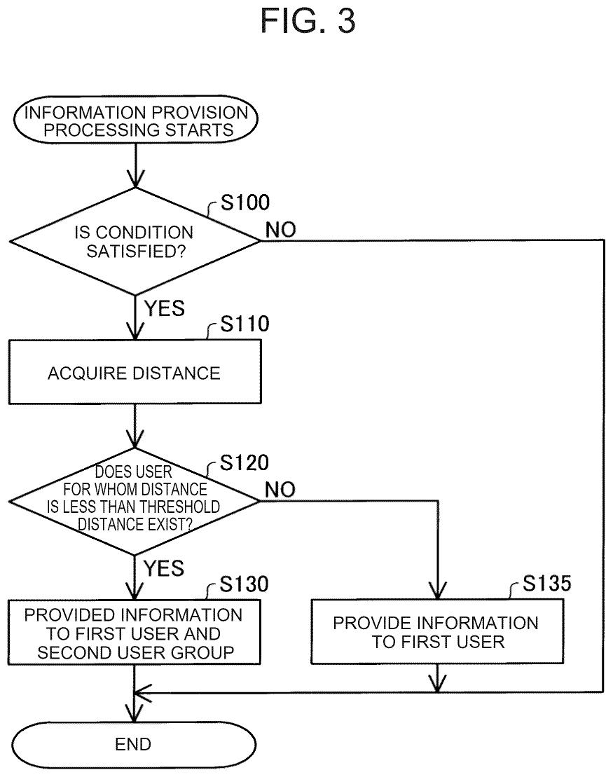

FIG. 3 is a flowchart indicating an example of information provision processing. The information provision processing is processing of the information provision system 10 providing information in accordance with the position of the user. This processing is processing to be repeatedly executed during operation of the information provision system 10. For example, the information provision system 10 repeats the information provision processing every 0.5 seconds. A case of the positional relationship of the users illustrated in FIG. 2 will be described below.

The information provision unit 122 determines whether the user UA that is the first user satisfies a determination condition in step S100. As the determination condition, for example, one or more of the following conditions can be employed.

A condition 1 is entry into a range determined in advance on the map. In other words, the condition 1 is entry into a region determined in advance. A condition 2 is that button operation determined in advance is performed.

The range determined in advance in the condition 1 is an arbitrarily determined range and preferably includes the position of the explanation target of the information to be provided by the information provision unit 122. It is determined that the condition 1 is satisfied, for example, when the position information of the user UA acquired by the information provision unit 122 from the first terminal device TA indicates that the user UA enters the range A1 determined in advance on the map.

The button determined in advance in the condition 2 is an arbitrarily determined button and is preferably a button provided in a device held by the first user. The button determined in advance may be a physical button or a virtual button displayed on a screen. It is determined that the condition 2 is satisfied, for example, when the information provision unit 122 receives information indicating that the button determined in advance provided in the first terminal device TA is depressed.

Further, the conditions 1 and 2 and other conditions may be combined as appropriate to be set as the determination condition. In the present embodiment, the condition 1 is employed as the determination condition.

The processing of the information provision unit 122 proceeds to step S110 when the first user satisfies the determination condition, that is, the user UA enters the range A1. On the other hand, the information provision unit 122 ends the information provision processing when the first user does not satisfy the determination condition, that is, the user UA does not enter the range A1.

The distance acquisition unit 121 executes a “distance acquisition step” of acquiring distances between the first user and all other users in step S110. In other words, the distance acquisition unit 121 acquires the distance L1 between the user UA and the user UB and the distance L2 between the user UA and the user UC.

The information provision unit 122 determines whether a user for whom the distance acquired in step S110 is less than the threshold distance Lth determined in advance exists in step S120. The threshold distance Lth is a distance at which the users can have a conversation and is, for example, 5 m. Further, the threshold distance Lth is preferably smaller than a radius of the range A1. The threshold distance Lth can be experimentally and empirically determined. When a user for whom the distance is less than the threshold distance Lth exists, the processing of the information provision unit 122 proceeds to step S130. On the other hand, when a user for whom the distance is less than the threshold distance Lth does not exist, the information provision unit 122 provides information only to the user UA that is the first user in step S135.

The information provision unit 122 provides information at the same time to the first user and a second user group in step S130. In the present embodiment, the second user group is some or all of users for whom the distances to the first user are less than the threshold, and the user UB corresponds to the “second user group” in the present disclosure. In other words, the information provision unit 122 provides information to the user UA and the user UB. Note that “the same time” in the present disclosure does not necessarily have to be completely the same and includes a temporal gap that can be dealt with as the same time.

The information provision unit 122 does not provide information to a third user group in step S130 and step S135. In the present embodiment, the third user group is some or all of users for whom the distances to the first user are equal to or greater than the threshold distance Lth, and the user UC corresponds to the “third user group” in the present disclosure. In other words, the information provision unit 122 does not provide information to the user UC in step S130. The processing in step S130 is also referred to as an “information provision step”.

According to the information provision system 10 of the present embodiment described above, when the user UA that is the first user satisfies the determination condition, the information provision unit 122 provides information at the same time to the user UB that is the second user group for whom the distance to the first user is less than the threshold distance Lth and to the user UA that is the first user, so that the second user group can share fun and amazement by enjoying the information, with the first user. Further, when the first user satisfies the determination condition, the information provision unit 122 does not provide information to the user UC that is the third user group for whom the distance to the first user is equal to or greater than the threshold distance Lth, so that it is possible to prevent information from being provided at a timing at which the third user group cannot enjoy the information. It is therefore possible to provide the information at a timing appropriate for each of a plurality of users.

Further, the determination condition is entry into the range A1 determined in advance on the map. Thus, when the first user enters the range A1, the information can be provided.

Further, the sound reproduction device 200 reproduces sound subjected to stereophonic processing. Thus, the information provision system 10 can provide information to the user while causing the user to feel a realistic feeling,

### Second Embodiment

A second embodiment is different from the first embodiment in that the information provision unit 122 provides information to a fourth user group that is some or all of users that satisfy the determination condition among the third user group and synchronizes provision of the information to the first user with provision of the information to the fourth user group. A configuration of the information provision system 10 of the second embodiment is the same as the configuration of the information provision system 10 of the first embodiment, and thus, description of the configuration of the information provision system 10 will be omitted.

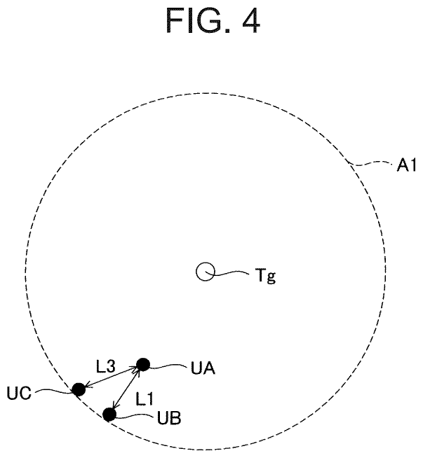

FIG. 4 is a view illustrating an example of a positional relationship of the user in the second embodiment. The user UA and the user UB have not moved from the state illustrated in FIG. 2. The user C has moved within the range A1. A distance L3 between the user UC and the user UA is less than the threshold distance Lth.

The information provision unit 122 provides information to the fourth user group that is a user who has entered the range A1 determined in advance on the map among the third user group. In the present embodiment, the user UC corresponds to the “fourth user group” in the present disclosure.

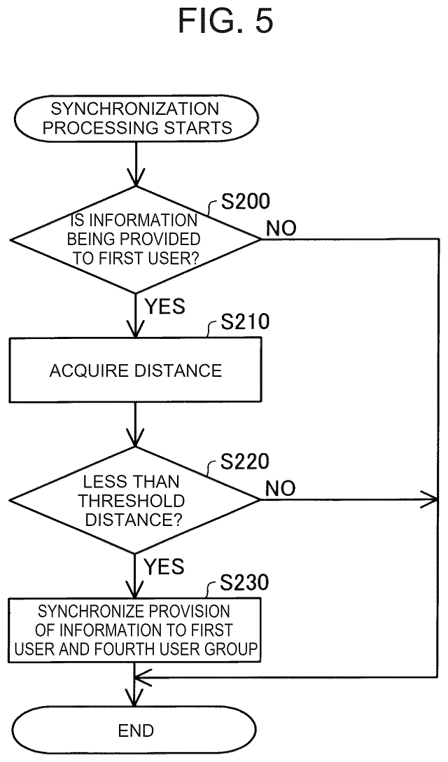

FIG. 5 is a flowchart indicating an example of synchronization processing. The synchronization processing is processing of synchronizing provision of the information to the first user with provision of the information to the fourth user group. This processing is processing to be repeatedly executed while the information is being provided to the fourth user group. In the following description, as described in the first embodiment, a case will be described as an example where the positional relationship changes from the positional relationship illustrated in FIG. 2 where the information provision unit 122 provides information at the same time to the user UA and the user UB in the information provision processing and does not provide the information to the user UC, to the positional relationship of the users illustrated in FIG. 4, and the information provision unit 122 provides the information to the user UC.

The information provision unit 122 determines whether the information is being provided to the user UA that is the first user in step S200. When the information is being provided, that is, provision of the information is not completed, the processing of the information provision unit 122 proceeds to step S210. On the other hand, when the information is not being provided, that is, provision of the information is completed, the information provision unit 122 ends the synchronization processing.

The information provision unit 122 acquires a distance between the first user and the fourth user group in step S210. In other words, the information provision unit 122 acquires the distance L3 between the user UA and the user UC.

The information provision unit 122 determines whether the distance L3 acquired in step S210 is less than the threshold distance Lth in step S220. When the distance L3 is less than the threshold distance Lth, the processing of the information provision unit 122 proceeds to step S230. On the other hand, when the distance L3 is equal to or greater than the threshold distance Lth, the information provision unit 122 ends the synchronization processing.

The information provision unit 122 synchronizes provision of the information to the first user and the fourth user group in step S230. The synchronization of provision of the information is to control an aspect of provision of the information such that a degree of progress of provision of the information to the first user is aligned with a degree of progress of provision of the information to the fourth user group. In the present embodiment, the information provision unit 122 aligns the degree of progress of provision of the information to the first user and the second user group with the degree of progress of provision of information to the fourth user group. For example, the information provision unit 122 causes the first sound reproduction device 200A and the second sound reproduction device 200B to pause reproduction of sound. Then, the information provision unit 122 causes the first sound reproduction device 200A and the second sound reproduction device 200B to restart reproduction of the sound at a timing at which reproduction of the sound by the third sound reproduction device 200C catches up with reproduction by the first sound reproduction device 200A and the second sound reproduction device 200B.

According to the information provision system of the second embodiment described above, when the distance L3 between the first user and the fourth user group approaches less than the threshold distance Lth, the information provision unit 122 synchronizes provision of the information to the first user with provision of the information to the fourth user group. Thus, even if the first user and the fourth user group approach each other after provision of the information to the first user is started, the first user and the fourth user group can share enjoyment of the information at the same timing.

### Other Embodiments

In the above-described embodiment, the information to be provided to the user is stored in the memory 110 of the information provision device 100. The present disclosure is not limited to this, and the information may be stored in an external server.

In the above-described embodiment, the first terminal device TA owned by the user UA that is the first user may be the information provision device 100. Further, some or all of the terminal devices T owned by the users UA, UB, UC may be the information provision devices 100.

In the above-described embodiment, the information provision system 10 includes the sound reproduction device 200, and the information provision system 10 provides information to the users UA, UB, UC via the sound reproduction device 200. The present disclosure is not limited to this, and the information provision system 10 does not have to include the sound reproduction device 200. In this case, the information provision device 100 may provide information, for example, using an image or text via the terminal device T.

In the above-described embodiment, the information provision system 10 provides the information to three users. The present disclosure is not limited to this, and the information provision system 10 may provide the information to two users or four or more users.

In the above-described embodiment, the information provision device 100 may select information to be provided in accordance with the position of the user. In this case, the memory 110 stores range information representing the range determined in advance on the map and provision information that is information to be provided to the user and that is associated with the range information. The information provision device 100 provides the provision information associated with one piece of range information representing a range including a current position of the first user.

In the above-described embodiment, the first user is a user determined in advance among the plurality of users. The first user is not limited to this, and a user who satisfies a first user condition determined in advance may be set as the first user. As the first user condition, for example, a condition that the user is a user who satisfies the determination condition first can be employed.

In the above-described embodiment, the second user group is users for whom the distances to the first user are less than the threshold distance Lth among the users other than the first user. The second user group is not limited to this, and users for whom the distances to the first user are less than the threshold distance Lth and who satisfy a second user condition determined in advance among the users other than the first user may be set as the second user group. As the second user condition, for example, a condition that a user is located within a range which includes the range A1 in the determination condition, and from which the explanation target Tg of the information to be provided is visible, can be employed. This enables the second user group to enjoy provision of the information while visually confirming the explanation target Tg.

In the above-described embodiment, the distance acquisition unit 121 calculates distances between the first user and all other users using the position information of the respective users detected by the GNSS acquired from the terminal devices T. The present disclosure is not limited to this, and the distance acquisition unit 121 may acquire the distances between the first user and all other users, calculated by another component included in the information provision system 10. Further, the position information may be obtained using an image captured by an imaging device.

In the above-described embodiment, the information provision unit 122 performs stereophonic processing. The present disclosure is not limited to this, and another component included in the information provision system 10 may perform stereophonic processing. Further, the information provision system 10 may omit the stereophonic processing.

In the above-described embodiment, the threshold distance Lth is a distance determined in advance. The threshold distance Lth is not limited to this, may be determined by the user and may be determined in accordance with largeness of the range A1 in the determination condition, a moving speed of the first user, and the position of the first user. The information provision device 100, for example, can set a greater threshold distance Lth when a road width of a road on which the first user is located is a first width than the threshold distance Lth when the road width of the road on which the first user is located is smaller than the first width. By this means, it is possible to set a threshold distance appropriate for the position of the first user.

In the above-described embodiment, when the first user satisfies the determination condition, the information provision unit 122 provides the information to the first user. The present disclosure is not limited to this, and the information provision unit 122 may provide the information to the first user when the first user satisfies the determination condition and some or all of all other users satisfy a condition determined in advance. The condition determined in advance may be, for example, the same as or different from the determination condition. In this case, further, when the first user satisfies a second determination condition determined in advance different from the determination condition, the information provision unit 122 may provide the information to the first user regardless of whether other users satisfy the condition determined in advance. For example, the information provision unit 122 provides the information to the first user when the first user and some of other users enter the range A1. Further, when the first user enters a range determined in advance included in the range A1, the information provision unit 122 provides the information to the first user regardless of whether other users enter the range A1.

In the above-described first embodiment, the information provision unit 122 may provide the information to users to whom the information is not provided at the same time as the first user when the users satisfy a condition determined in advance. The condition determined in advance may be the same as or different from the determination condition.

In the above-described second embodiment, the fourth user group is users who satisfy the determination condition among the third user group. The fourth user group is not limited to this and may be users who satisfy a condition different from the determination condition among the third user group.

In the above-described second embodiment, the information provision unit 122 synchronizes provision of the information by pausing provision of the information. The present disclosure is not limited to this, and the information provision unit 122 may, for example, perform control to make reproduction speeds of the first sound reproduction device 200A and the second sound reproduction device 200B lower than normal and/or make a reproduction speed of the third sound reproduction device 200C higher than normal to achieve synchronization.

The present disclosure is not limited to the above-described embodiments and can be implemented with various configurations within a range not deviating from the gist. For example, technical features in the embodiments corresponding to technical features in the respective aspects described in summary of the present disclosure can be replaced or combined as appropriate to solve some or all of the above-described problems or to achieve some or all of the above-described effects. Further, the technical features can be deleted as appropriate if they are not described as essential in the present specification.

1. An information provision system comprising a processor configured to
acquire distances between a first user among a plurality of users and all other users other than the first user among the plurality of users, wherein
when the first user satisfies a determination condition determined in advance, the processor is configured to provide information determined in advance at the same time to the first user and a second user group that is some or all of users located at the distances less than a threshold distance determined in advance among the all other users, and is configured not to provide the information to a third user group that is some or all of users located at the distances equal to or greater than the threshold distance among the all other users.

2. The information provision system according to claim 1, wherein the determination condition includes entry into a first region determined in advance.

3. The information provision system according to claim 2, wherein:
the processor is further configured to provide the information to a fourth user group that is some or all of users who satisfy the determination condition among the third user group; and
when the information is being provided to the first user, and the distance between the first user and the fourth user group is less than the threshold distance, synchronize a degree of progress of provision of the information to the first user with a degree of progress of provision of the information to the fourth user group.

4. The information provision system according to claim 2, wherein:
the first region includes a position of an explanation target of the information; and
the second user group is some or all of users who are located at the distances less than the threshold distance among the all other users, and who are located in a second region determined in advance, the second region being a region that includes the first region and from which the explanation target is visible.

5. The information provision system according to claim 1, wherein the threshold distance when the first user is located on a road with a first width is greater than the threshold distance when the first user is located on a road with a second width that is smaller than the first width.

6. The information provision system according to claim 1 configured to provide the information using sound, the information provision system further comprising a sound reproduction device to be worn on a head of each of the plurality of users, wherein:
the processor is configured to provide the sound as the information; and
the sound reproduction device is configured to reproduce the information subjected to stereophonic processing, the information subjected to stereophonic processing being an information that expresses a position of a sound source that is a virtual generation source of the sound as a relative position determined in advance with respect to a user who wears the sound reproduction device.

7. The information provision system according to claim 3, wherein the processor is configured to synchronize a degree of progress of provision of the information to the first user with a degree of progress of provision of the information to the fourth user group by stopping provision of the information to the first user for a predetermined period.

8. An information provision method comprising:
acquiring distances between a first user among a plurality of users and all other users among the plurality of users; and
when the first user satisfies a determination condition determined in advance, providing information determined in advance at the same time to the first user and a second user group that is some or all of users located at the distances less than a threshold distance determined in advance among the all other users, and not providing the information to a third user group that is some or all of users located at the distances equal to or greater than the threshold distance among the all other users.

9. A non-transitory storage medium storing instructions that cause a processor to perform functions comprising:
acquiring distances between a first user among a plurality of users and all other users among the plurality of users; and
when the first user satisfies a determination condition determined in advance, providing information determined in advance at the same time to the first user and a second user group that is some or all of users located at the distances less than a threshold distance determined in advance among the all other users, and not providing the information to a third user group that is some or all of users located at the distances equal to or greater than the threshold distance among the all other users.
